(19) United States
(12) Patent Application Publication
(10) Pub. No.: US 2023/0352730 A1
(43) Pub. Date: Nov. 2, 2023

(54) Lithium Secondary Battery

(71) Applicant: Nippon Telegraph and Telephone Corporation, Tokyo (JP)

(72) Inventors: Hironobu Minowa, Musashino-shi, Tokyo (JP); Akihiro Kono, Musashino-shi, Tokyo (JP); Takeshi Komatsu, Musashino-shi, Tokyo (JP)

(21) Appl. No.: 18/000,240

(22) PCT Filed: Jun. 2, 2020
(86) PCT No.: PCT/JP2020/021780

§ 371 Date: Nov. 29, 2022

(51) Int. Cl. H01M 10/0565; H01M 10/052

(52) U.S. Cl. CPC H01M 10/0565; H01M 10/052; H01M 2300/0082

(57) ABSTRACT

The present invention provides a lithium secondary battery comprising: a cathode that is capable of intercalating and deintercalating lithium ions; an anode that is capable of intercalating and deintercalating lithium ions; and a transparent electrolyte having lithium ion conductivity, wherein the cathode and the anode are each formed on a transparent substrate having a transparent conductive film formed thereon, and the electrolyte contains a solid electrolyte.

### TECHNICAL FIELD

The present invention relates to a lithium secondary battery.

### BACKGROUND ART

Lithium secondary batteries, which employs intercalation and deintercalation reactions of lithium ions, are being used worldwide as secondary batteries with high energy density for applications such as a variety of electronic instruments, automotive power sources, and electric power storage. Even today, research and development on electrode materials and electrolyte materials for lithium secondary batteries is still ongoing with the aim of improving performance and lowering costs.

In recent years, with the development of smartphones and IoT instruments, lithium secondary batteries are attracting greater attention as mobile power sources, and as power sources for transparent displays, ultrathin displays, and the like, the flexibility, design, and other characteristics of the batteries themselves may be demanded as well.

As for thin lithium secondary batteries, Hayashi et al. have reported in Non-Patent Literature 1 that a thin and bendable battery with a thickness on the order of μm can be fabricated by laminating LiPoN (transparent amorphous film that has expressed lithium ion conductivity by partially replacing oxygen in Li₃Po₄ with nitrogen) as the solid electrolyte, and metallic lithium as the anode and Cu as the anode current collector on the LiCoO₂ cathode film fabricated on the Pt/Ti collector electrode film, using RF (Radio Frequency) sputtering and vacuum deposition, respectively, and that the battery exhibits a discharge capacity of about 250 μAh/g at a discharge current with a current density of 0.1 mA/cm².

### CITATION LIST

### Non-Patent Literature

Non-Patent Literature 1: M. Hayashi, M. Takahashi and T. Shodai, J. Power Sources, 189, 416-422 (2009)

### SUMMARY OF THE INVENTION

### Technical Problem

As described above, there have been studies on thin and bendable secondary batteries. However, visible light transmittance has not been considered in Non-Patent Literature 1 or in commercially available batteries.

Also, as for anode materials, there is a limit on the anode materials that can be used, as their volume expands and contracts due to charge and discharge, and they become inactive when they are detached from the substrate. However, if it is possible to realize batteries using transparent materials, it is expected that the range of applications will be greatly expanded due to the design of devices and the possibility of utilizing them in various devices.

The present invention has been made in view of the problems described above, and it is intended to provide a lithium secondary battery that transmits visible light and has excellent charge/discharge cycle characteristics.

### Means for Solving the Problem

One aspect of the present invention is a lithium secondary battery comprising: a cathode that is capable of intercalating and deintercalating lithium ions; an anode that is capable of intercalating and deintercalating lithium ions; and a transparent electrolyte having lithium ion conductivity, wherein the cathode and the anode are each formed on a transparent substrate having a transparent conductive film formed thereon, and the electrolyte contains a solid electrolyte.

### Effects of the Invention

According to the present invention, a lithium secondary battery that transmits visible light and has excellent charge/discharge cycle characteristics can be provided.

### BRIEF DESCRIPTION OF DRAWINGS

FIG. 1A is a schematic top view showing the configuration of a lithium oxide according to an embodiment of the present invention.

FIG. 1B is a schematic cross sectional view showing the configuration of a lithium oxide according to an embodiment of the present invention.

FIG. 2 shows the light transmittance of a lithium secondary battery of Example 1.

FIG. 3 shows the initial charge/discharge curves of Examples 1 and 2, and Comparative Example.

FIG. 4 shows the discharge capacities until the 20th cycle of Experimental Examples 1 and 2, and Comparative Example.

FIG. 5 is a diagram where the anode is detached from the substrate and precipitates in the electrolytic solution.

### DESCRIPTION OF EMBODIMENTS

Hereinafter, an embodiment of the present invention will be described with reference to the accompanying drawings.

A lithium secondary battery of the present embodiment comprises: a cathode that is capable of intercalating and deintercalating lithium ions; an anode that is capable of intercalating and deintercalating lithium ions; and a transparent electrolyte having lithium ion conductivity. The cathode and the anode are each formed on a transparent substrate having a transparent conductive film formed thereon. The electrolyte contains a solid electrolyte.

Specifically, the cathode contains a substance that is capable of intercalating and deintercalating lithium ions. The anode contains metallic lithium, a metal that is capable of forming an alloy with lithium, or a substance that is capable of intercalating and deintercalating lithium ions.

The cathode and the anode can be fabricated by the following methods, for example, but the present invention is not limited to them.

First of all, a transparent conductive film such as ITO (indium tin oxide) is formed on the entire surface of a substrate having visible light transmittance such as glass. By fabricating a film of a substance that is capable of intercalating and deintercalating lithium ions at a predetermined thickness on the transparent conductive film of the base, the cathode is formed. The transparent conductive film and the cathode film are fabricated using approaches such as sputtering and vapor deposition. Note that the approaches for fabricating films are not limited to them.

Similarly, for the anode as well, a transparent conductive film such as ITO is formed on the entire surface of a substrate having visible light transmittance, and on the transparent conductive film, a film of a substance that is capable of intercalating and deintercalating lithium ions is fabricated at a predetermined thickness as the anode.

For the electrolyte of the present embodiment, a solid electrolyte having visible light transmittance can be used, which is a substance having lithium ion conductivity but not electronic conductivity. For example, as the solid electrolyte, at least one selected from the group consisting of oxides such as LISICON type, perovskite type, and garnet type, constituted by Li, Ba, Ca, Cl, Y, La, Sr, Cu, Bi, Zr, Ta, Nb, and the like; oxynitrides such as Li_{3.3}PO_{3.8}N_{0.22} (LiPON); glass ceramics constituted by Li, Ge, P, S, Si, Cl, and the like; sulfides such as Thio-LISICON; and hydrides such as LiBH₄, 3LiBH₄—LiI, and Li₂(CB₉H₁₀)(CB₁₁H₁₂) can be used.

Also, as the solid electrolyte, a polymer electrolyte may be used, in which an organic material, polymer, has been added to give flexibility and pliability that cannot be obtained with inorganic materials alone. As the polymer electrolyte, for example, one in which poly(tetrafluoroethylene) (PTFE) or poly(vinylidene fluoride) (PVdF) and a lithium salt are dissolved in tetrahydrofuran (THF) can be used.

It is also possible to use a separator having translucency such as polyethylene (PE), polypropylene (PP), and ion exchange membranes, impregnated with an electrolyte. For example, the lithium secondary battery may include a separator between the cathode and the anode. In this case, it is possible to use a separator having translucency, impregnated with a liquid electrolyte. Alternatively, a liquid electrolyte such as organic electrolyte or aqueous electrolyte may be solidified by impregnating a polymer electrolyte or the like with it.

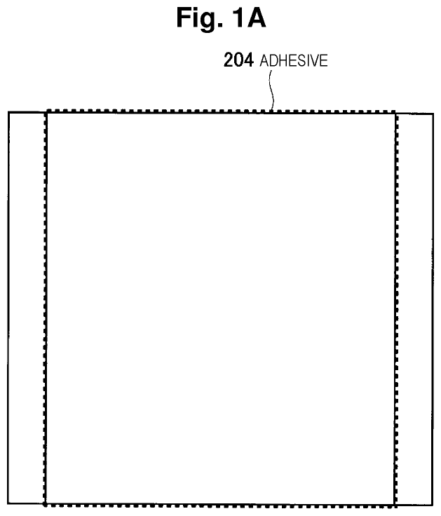

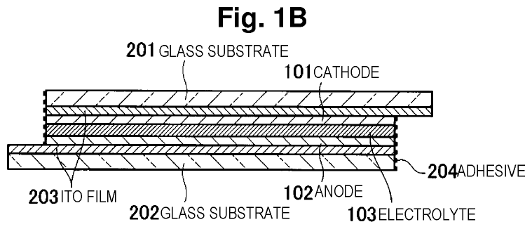

FIG. 1A and FIG. 1B are diagrams schematically showing the configuration of the lithium secondary battery of the present embodiment. FIG. 1A is a schematic top view of the lithium secondary battery. FIG. 1B is a schematic cross sectional view of the lithium secondary battery. The illustrated lithium secondary battery includes a cathode 101, an anode 102, and an electrolyte 103 arranged between the cathode 101 and the anode 102. The electrolyte 103 is in contact with the cathode 101 and the anode 102.

The lithium secondary battery can also include a transparent substrate 201 for the cathode, a transparent substrate 202 for the anode, a transparent conductive film 203, and an adhesive 104. In the present embodiment, ITO (indium tin oxide) is used as the transparent conductive film 203. Hereinafter, the transparent conductive film 203 is also referred to as the ITO 203. Also, in the present embodiment, glass substrates are used for the transparent substrates 201 and 202 for the cathode and the anode.

This lithium secondary battery can be adjusted by, for example, arranging the cathode 101, the anode 102, and the solid electrolyte 103 as desired on the respective transparent substrates 201 and 202 on which the ITO films 203 have been fabricated, and sealing the transparent substrates 201 and 202 with the adhesive 204 so as to cover the edges thereof, such that only the respective electrode terminal units of the cathode 101 and the anode 102 are exposed to the outside. Note that, instead of the adhesive 204, a seal or the like may be used for the sealing.

In the present embodiment, the transparent solid electrolyte 103 is sandwiched between the transparent substrate 201 for the cathode and the transparent substrate 202 for the anode, and sealed in vacuum using the adhesive 104, seal material, or the like. As a result, the present embodiment can submit a lithium secondary battery that transmits visible light and that can suppress the detachment of the cathode 101 and the anode 102 from the transparent substrates 201 and 202.

Hereinafter, Examples of the lithium secondary battery of the present embodiment will be described in detail. The present invention is not limited to those shown in the following Examples, and can be implemented with appropriate modifications to the extent that the spirit and scope of the present invention are not changed.

### Example 1

A lithium secondary battery of Example 1 was fabricated by the following procedures.

Glass Substrate with ITO

In Example 1, a glass substrate of 100 mm (length)×100 mm (width) and 2 mm (thickness) is used for each of the transparent substrates 101 and 102 for the cathode 101 and anode 102. Each of the glass substrates 101 and 102 was coated with the ITO 203 by RF sputtering to a thickness of 150 nm, thereby fabricating a film. The sputtering was carried out using an ITO (5 wt % SnO₂) target at a RF output of 100 W with an argon flow of 1.0 Pa.

Cathode

On an area of 90 mm (length)×100 mm (width) of the glass substrate 201 on which the film of ITO 203 is fabricated, a film of lithium cobalt phosphate (LiCoPO₄) was formed at a thickness of 200 nm as the cathode 101 by RF sputtering. The sputtering was carried out using a LiCoPO₄ ceramic target under conditions where the distribution partial pressure ratio of argon and oxygen was 3:1, the total gas pressure was 3.7 Pa, and the RF output was 700 W.

In the cathode 101 in which the film was fabricated in this way, there is a part of 10 mm (length)×100 mm (width) where no film of cathode material was fabricated and the ITO 203 was exposed. This exposed part is utilized as the electrode terminal.

Anode

On an area of 90 mm (length)×100 mm (width) of the glass substrate 202 on which the film of ITO 203 is fabricated, a film of silicon oxide (SiO) was formed at a thickness of 100 nm as the anode 102 by RF sputtering. The sputtering was carried out using a SiO ceramic target under conditions where the distribution partial pressure ratio of argon and oxygen was 3:1, the total gas pressure was 4.0 Pa, and the RF output was 700 W.

In the anode 102 in which the film was fabricated in this way, there is a part of 10 mm (length)×100 mm (width) where no film of anode material was fabricated and the ITO 203 was exposed. This exposed part is utilized as the electrode terminal.

Electrolyte

Lithium phosphate (Li₃PO₄) was used as the electrolyte 103. On the entire surface of the cathode 101 (LiCoPO₄ film) fabricated as described above, a film of lithium phosphate (Li₃PO₄) was formed at a thickness of 200 nm as the electrolytic solution 103 by RF sputtering. The sputtering was carried out using a Li₃PO₄ ceramic target under conditions where the distribution partial pressure ratio of argon and oxygen was 3:1, the total gas pressure was 3.7 Pa, and the RF output was 700 W.

From the top of the cathode 101 and electrolyte 103 fabricated in this way, 30 μL of an organic electrolytic solution in which lithium bis(trifluoromethanesulfonyl)imide (LiTFSI) was dissolved as a lithium salt in propylene carbonate (PC) at a concentration of 1 mol/L was poured into the center of the glass substrate 201 for the cathode, and after fixing the glass substrate 201 on a rotary table, it was rotated at 50 rpm to cast the electrolytic solution 103.

Battery Fabrication

As for the anode 102 fabricated as described above, the transparent base 201 on which the cathode 101 and the electrolyte 103 have been formed and the transparent substrate 204 on which the anode 102 has been formed are superimposed such that the ITO 203 is exposed from each of the transparent base 201 for the cathode and the transparent substrate 202 for the anode. As for this superimposed object, the edges of the area of 90 mm (length)×100 mm (width), where the cathode 101, the electrolyte 103, and the anode 102 were overlapped, were sealed with the adhesive 204, and before the adhesive 204 got hardened, it was put into a vacuum dryer and vacuum dried to harden the adhesive 204, thereby fabricating a lithium secondary battery.

Battery Performance

In a charge/discharge test of the lithium secondary battery, charge and discharge were performed at a current density per effective area of the cathode (anode) of 1 μA/cm², using a commercially available charge/discharge measurement system. The charge/discharge test was carried out in the voltage range with a charge end voltage of 5.0 V and a discharge end voltage of 3.0 V.

In the charge/discharge test of the lithium secondary battery, the measurement was carried out in a thermostatic tank at 25° C. (the atmosphere was under a normal atmospheric environment).

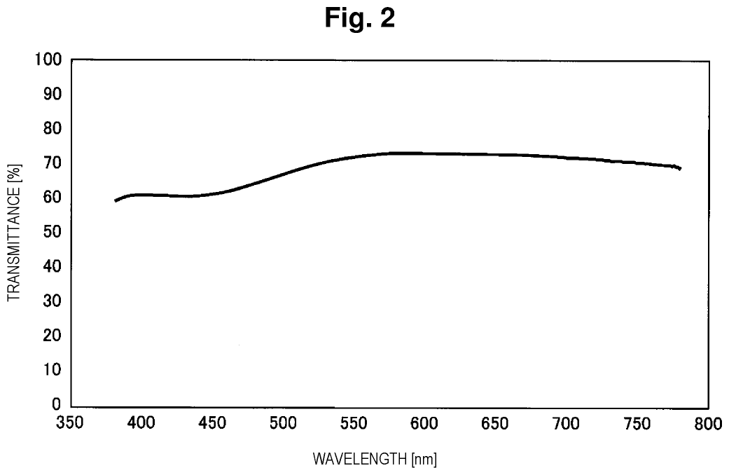

FIG. 2 shows the results of measuring the light transmittance of the lithium secondary battery fabricated in Example 1 in the visible light region. The lithium secondary battery of Example 1 exhibits a transmittance of 60% or more in the visible light region (about 400 nm to 780 nm). Accordingly, it can be seen that the lithium secondary battery of Example 1 transmits visible light.

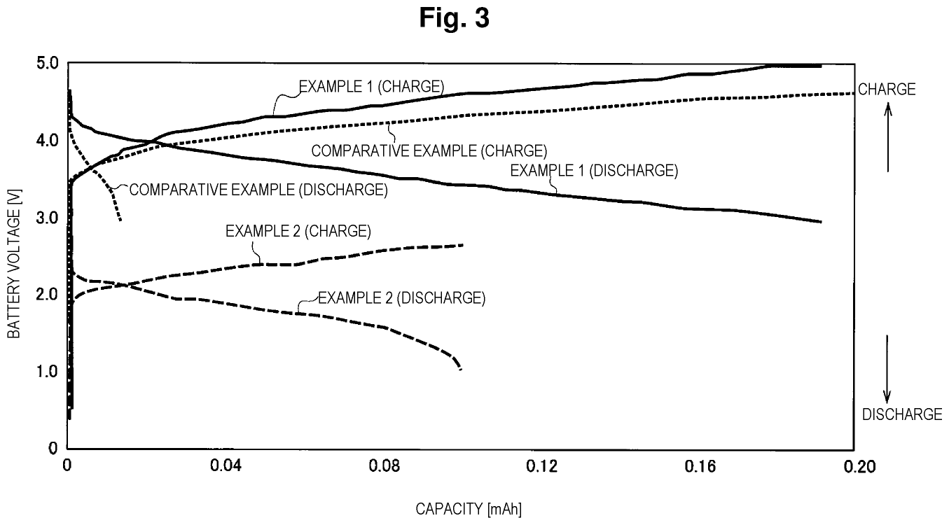

FIG. 3 shows the initial charge/discharge curves of Example 1, and Example 2 and Comparative Example, which will be mentioned later. In FIG. 3, the solid lines show the charge characteristics and discharge characteristics of Experimental Example 1. The dashed line shows the charge characteristics and discharge characteristics of Experimental Example 2, and the dotted line shows the charge characteristics and discharge characteristics of Comparative Example.

From FIG. 3, it can be seen that the lithium secondary battery of Example 1 is capable of reversible charge and discharge with small irreversible capacity (difference between charge capacity and discharge capacity), and has a discharge capacity of about 0.192 mAh and an average discharge voltage of about 3.8 V.

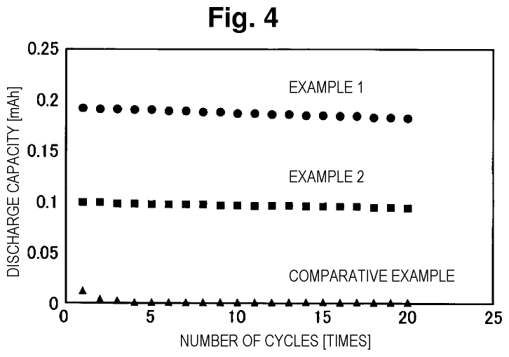

FIG. 4 shows the discharge capacities from the first time to the 20th cycle of Experimental Example 1, Example 2 and Comparative Example. From FIG. 4, it can be seen that the lithium secondary battery of Example 1 has stable cycle characteristics, with only a capacity reduction as small as approximately 0.01 mAh at the 20th cycle.

As described above, the lithium secondary battery of the present Example transmits visible light, has excellent charge/discharge cycle characteristics, and has a high energy density. Specifically, in the present example, detachment of the SiO anode with a high energy density from the glass substrate due to volume expansion and contraction can be suppressed by using the solid electrolyte, thereby realizing a lithium secondary battery that is capable of stable charge/discharge cycles.

### Example 2

Anode

In Example 2, lithium titanate (Li₄Ti₅O₁₂) was used as the anode 102. Li₄Ti₅O₁₂ is a material that is not likely to undergo volume expansion and contraction. In the present Example, a lithium secondary battery was fabricated by the same method as in Example 1, except for the anode 102.

Battery Performance

In a charge/discharge test of the lithium secondary battery, charge and discharge were performed at a current density per effective area of the cathode (anode) of 1 μA/cm², using a commercially available charge/discharge measurement system. The charge/discharge test was carried out in the voltage range with a charge end voltage of 2.8 V and a discharge end voltage of 1.0 V. In the charge/discharge test of the battery, the measurement was carried out in a thermostatic tank at 25° C. (the atmosphere was under a normal atmospheric environment).

The lithium secondary battery of the present Example has stable cycle characteristics, as shown in FIG. 3 and FIG. 4. Note that the lithium secondary battery of the present Example has a smaller energy density (discharge voltage and capacity) compared to Example 1.

Also, the results of measuring the light transmittance of the lithium secondary battery of the present Example in the visible light region are shown in Table 1, which will be mentioned later. The lithium secondary battery of the present Example exhibits a transmittance of 60% or more in the visible light region (about 400 nm to 780 nm). Accordingly, the lithium secondary battery of the present Example transmits visible light.

### Example 3

In the present Example, the glass substrates with ITO 201 and 201, the cathode 101, and the anode 102 were fabricated by the same procedure as in Example 1.

Electrolyte

In Example 3, a polymer electrolyte formed by adding a polymer to the electrolyte 103 was used. Specifically, in the present Example, polyvinylidene fluoride (PVdF) powder as the binder, an organic electrolytic solution in which lithium bis(trifluoromethanesulfonyl)imide (LiTFSI) was dissolved as a lithium salt in propylene carbonate (PC) at a concentration of 1 mol/L, and tetrahydrofuran (THF) as the dispersion medium were mixed at a weight ratio of 4:6:10. The resulting solution was stirred at 60° C. for 1 hour in dry air with a dew point of −50° C. or lower, and 50 ml of the solution was poured into a 200ϕ Petri dish and vacuum dried at 50° C. for 12 hours, thereby fabricating a transparent film (polymer electrolyte) with a thickness of 0.1 mm.

Battery Fabrication

The polymer electrolyte 103 described above was molded into 90 mm (length)×100 mm (width). By sandwiching the polymer electrolyte 103 between the cathode 101 and the anode 102 such that the film fabricated surfaces of the polymer electrolyte 103 face the cathode 101 and the anode 102 and that only the film fabricated surfaces are entirely covered, the transparent base 201 for the cathode, the polymer electrolyte 103, and the transparent substrate 202 for the anode are superimposed. As for this superimposed object, the edges of the area of 90 mm (length)×100 mm (width), where the cathode 101, the polymer electrolyte 103, and the anode 102 were overlapped, were sealed with the adhesive 204, and before the adhesive 204 got hardened, it was put into a vacuum dryer and vacuum dried to harden the adhesive 204, thereby fabricating a lithium secondary battery.

Battery Performance

In a charge/discharge test of the lithium secondary battery, charge and discharge were performed at a current density per effective area of the cathode (anode) of 1 μA/cm², using a commercially available charge/discharge measurement system. The charge/discharge test was carried out in the voltage range with a charge end voltage of 5.0 V and a discharge end voltage of 2.5 V. In the charge/discharge test of the battery, the measurement was carried out in a thermostatic tank at 25° C. (the atmosphere was under a normal atmospheric environment).

Table 1 shows the initial discharge capacity, average discharge voltage, discharge capacity at the 20th cycle, and transmittance in the visible light region of Example 3. From Table 1, it can be seen that Example 3 exhibits even more stable cycle characteristics than Example 1. This can be attributed to the fact that the use of the polymer electrolyte, as opposed to the solid electrolytes such as oxides, allows for better adhesiveness of the anode due to the flexibility inherent in polymers, which acts as a buffer for the volume expansion of the anode, and thus more effectively suppresses the deactivation caused by the anode being detached from the glass substrate. The lithium secondary battery of Example 3 exhibits a transmittance of 70% or more in the visible light region (about 400 nm to 780 nm). Accordingly, the lithium secondary battery of Example 3 transmits visible light.

TABLE 1

| | | | | Transmittance |
|---|---|---|---|---|
| | Initial | Average | Discharge | (%) in |
| | discharge | discharge | capacity at | visible light |
| | capacity | voltage | 20th cycle | region (400 |
| | (mAh) | (V) | (mAh) | to 780 nm) |
| Example 1 | 0.192 | 3.8 | 0.182 | >60 |
| Example 2 | 0.099 | 1.8 | 0.093 | >60 |
| Example 3 | 0.196 | 4.0 | 0.191 | >70 |
| Comparative | 0.012 | 3.5 | 0.000 | >65 |
| Example | | | | |

### Comparative Example

In Comparative Example, the glass substrates with ITO, the cathode, and the anode were fabricated by the same procedure as in Example 1.

Electrolyte

In Comparative Example, only an organic electrolytic solution in which lithium bis(trifluoromethanesulfonyl)imide (LiTFSI) was dissolved as a lithium salt in propylene carbonate (PC) at a concentration of 1 mol/L was used as the electrolyte.

Battery Fabrication

A spacer of 100 mm (length)×70 mm (width)×0.5 mm (thickness) was sandwiched between the glass substrate with ITO for the cathode and the glass substrate with ITO for the anode, three edges of the four sides of the area of 90 mm (length)×100 mm (width), where the cathode and the anode were overlapped, were sealed with the adhesive, and the adhesive was hardened. Thereafter, the spacer was pulled out, the organic electrolytic solution described above was injected through the gap of one open side until the entire area of 90 mm (length)×100 mm (width) was filled with the organic electrolytic solution, and the one open side was sealed with the adhesive, thereby fabricating a lithium secondary battery.

Battery Performance

In a charge/discharge test of the lithium secondary battery, charge and discharge were performed at a current density per effective area of the cathode (anode) of 1 μA/cm², using a commercially available charge/discharge measurement system. The charge/discharge test was carried out in the voltage range with a charge end voltage of 5.0 V and a discharge end voltage of 3.0 V. In the charge/discharge test of the lithium secondary battery, the measurement was carried out in a thermostatic tank at 25° C. (the atmosphere was under a normal atmospheric environment).

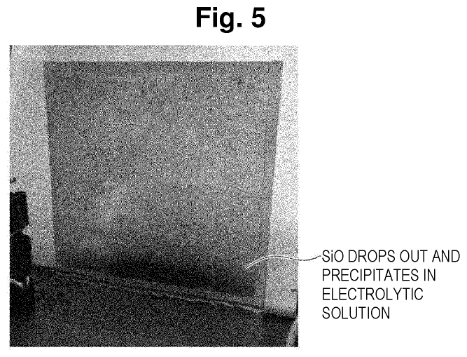

As shown in FIG. 3, FIG. 4, and Table 1, Comparative Example exhibits a large capacity in the initial charge, but the capacity significantly declines in the subsequent discharge. This can be attributed to the fact that, although the SiO anode has a large energy density, its volume expanded during lithium ion intercalation at the time of charge, causing the anode to be detached from the glass substrate, on which the ITO film is fabricated, in the organic electrolytic solution and deactivated, as shown in FIG. 5.

On the other hand, Examples 1 to 3 utilize solid electrolytes and the anode is physically held against the glass substrate with ITO, which suppresses detachment and is thought to provide stable charge/discharge cycle characteristics.

### Examples 4 to 7

In Examples 4 to 7, the glass substrates with ITO 201 and 201, the cathode 101, and the anode 102 were fabricated by the same procedure as in Example 1.

Electrolyte

The electrolyte 103 of Examples 4 to 7 was made by adjusting the film thickness of the polymer electrolyte of Example 3 (0.1 mm). The film thickness of Example 4 is 0.05 mm, the film thickness of Example 5 is 0.5 mm, the film thickness of Example 6 is 1 mm, and the film thickness of Example 7 is 2 mm.

Battery Fabrication

Lithium secondary batteries of Examples 4 to 7 were fabricated by the same procedures as in Example 3, using polymer electrolytes with the respective film thicknesses.

Battery Performance

In a charge/discharge test of the lithium secondary batteries of Examples 4 to 7, charge and discharge were performed at a current density per effective area of the cathode (anode) of 1 μA/cm², using a commercially available charge/discharge measurement system. The charge/discharge test was carried out in the voltage range with a charge end voltage of 5.0 V and a discharge end voltage of 2.5 V. In the charge/discharge test of the battery, the measurement was carried out in a thermostatic tank at 25° C. (the atmosphere was under a normal atmospheric environment).

Table 2 shows the initial discharge capacity, average discharge voltage, and discharge capacity at the 20th cycle of the lithium secondary batteries of Examples 3 to 7. Example 3 is the lithium secondary battery mentioned above, in which the polymer electrolyte has a film thickness of 0.1 mm. The lithium secondary batteries of Examples 4 to 7 exhibit a transmittance of 65% or more in the visible light region (about 400 nm to 780 nm). Accordingly, the lithium secondary batteries of Examples 4 to 7 transmit visible light.

TABLE 2

| | Film | | | | Transmit- |
|---|---|---|---|---|---|
| | thickness | Initial | Average | Discharge | tance (%) in |
| | of elec- | discharge | discharge | capacity at | visible light |
| | trolyte | capacity | voltage | 20th cycle | region (400 |
| | (mm) | (mAh) | (V) | (mAh) | to 780 nm) |
| Example 4 | 0.05 | 0.088 | 3.6 | 0.032 | >70 |
| Example 3 | 0.1 | 0.196 | 4.0 | 0.191 | >70 |
| Example 5 | 0.5 | 0.194 | 4.0 | 0.190 | >70 |
| Example 6 | 1 | 0.193 | 4.0 | 0.190 | >65 |
| Example 7 | 2 | 0.112 | 3.8 | 0.105 | >65 |

Examples 3, 5, and 6, in which the electrolyte has a film thickness of 0.1 to 1 mm, exhibit almost the same performance. On the other hand, in the lithium secondary battery (Example 4), in which the film thickness is too thin (less than 0.1 mm), the cycle characteristics are deteriorated. Also, in the lithium secondary battery (Example 7), in which the film thickness is too thick (2 mm), the discharge voltage decreases.

The deterioration of cycle characteristics can be attributed to the fact that, when the film thickness of the electrolyte is thin, the buffering effect of the volume expansion of the anode is not demonstrated, resulting in deactivation. The decrease in discharge voltage can be attributed to the fact that, when the film thickness of the electrolyte is thick, the distance of ionophoresis in the electrolyte becomes longer, which causes the internal resistance of lithium secondary battery to increase. For these reasons, it is desirable that the film thickness of the polymer electrolyte is 0.1 to 1 mm.

According to the above embodiment, it is possible to fabricate a lithium secondary battery that has visible light transmittance, excellent charge/discharge cycle characteristics, and a high energy density. Also, the lithium secondary battery of the present embodiment can be used as a driving source for a variety of electronic instruments and the like.

Note that the present invention is not limited to the embodiment described above, and a variety of modifications and combinations can be made within the technical idea of the present invention.

### Reference Signs List

101 Cathode
102 Anode
103 Electrolyte
201, 202 Glass substrate (transparent substrate)
203 ITO (transparent conductive film)
204 Adhesive

1. A lithium secondary battery comprising:
a cathode that is capable of intercalating and deintercalating lithium ions;
an anode that is capable of intercalating and deintercalating lithium ions; and
a transparent electrolyte having lithium ion conductivity,
wherein the cathode and the anode are each formed on a transparent substrate having a transparent conductive film formed thereon, and
the electrolyte contains a solid electrolyte.

2. The lithium secondary battery according to claim 1, wherein a polymer is added to the electrolyte.

3. The lithium secondary battery according to claim 1, wherein the electrolyte has a thickness of 0.1 to 1 mm.

4. The lithium secondary battery according to claim 2, wherein the electrolyte has a thickness of 0.1 to 1 mm.
